(19) United States
(12) Patent Application Publication
(10) Pub. No.: US 2003/0032449 A1
(43) Pub. Date: Feb. 13, 2003

(54) Personal digital assistant telephone with wireless headset

(76) Inventor: John J. Giobbi, Northbrook, IL (US)

Correspondence Address: Michael J. Blankstein, 7358 New Washburn Way, Madison, WI, 53719, US

(21) Appl. No.: 10/217,016

(22) Filed: Aug. 12, 2002

Related U.S. Application Data
(60) Provisional application No. 60/312,127, filed on Aug. 13, 2001.

(51) Int. Cl. H04B 5/00; H04M 1/00; H04B 1/38

(52) U.S. Cl. 455/556; 455/568; 455/566; 455/41

(57) ABSTRACT

A PDA telephone comprises a wireless headset and a main hand-held unit. The wireless headset includes a first wireless transceiver, a speaker, and a microphone. The speaker and the microphone are coupled to the first wireless transceiver. The hand-held unit receives, processes, and displays personal organizer information. The hand-held unit includes a second wireless transceiver, an antenna, and wireless telephony circuitry coupled to the second wireless transceiver and the antenna. The hand-held unit is free of a telephone speaker and a telephone microphone. The second wireless transceiver transmits incoming audio signals to and receives outgoing audio signals from the first wireless transceiver. By eliminating the speaker and the microphone from the hand-held unit and instead incorporating these items in the wireless headset, the size, weight, cost, complexity, and convenience and efficiency of use of the PDA telephone are optimized.

### REFERENCE TO RELATED APPLICATION

This application claims the benefit of U.S. Provisional Application No. 60/312,127, filed Aug. 13, 2001.

### FIELD OF THE INVENTION

The present invention relates generally to personal digital assistants (PDAs) and, more particularly, to a PDA telephone with a wireless headset.

### BACKGROUND OF THE INVENTION

A personal digital assistant (PDA) is a term for any small mobile hand-held computer that provides computing, information storage and information retrieval capabilities for personal or business use. Examples of PDAs are the Palmtop by Hewlett-Packard and the PalmPilot by 3Com. Most PDAs have a small keyboard and some PDAs include an electronically sensitive pad on which handwriting can be received using a stylus.

PDAs are typically used as a personal organizer for keeping schedule calendars, storing and retrieving address book information, and entering notes. The PDA can typically be connected to desktop computers to upload and download information. Increasingly, PDAs are also used as a wireless (cellular) telephone. To serve as a wireless telephone, the main hand-held unit of the PDA includes integrated or add-on wireless telephone circuitry for communicating with a wireless telephone system. Also, the hand-held unit includes an integrated speaker and microphone. The speaker transmits sound corresponding to audio signals received by the PDA from the wireless telephone system. The microphone receives sound from a user, and the PDA transmits corresponding audio signals to the wireless telephone system. By integrating the speaker and the microphone in the hand-held unit of the PDA, the size, weight, cost, complexity, and convenience and efficiency of use of the PDA are undermined.

### SUMMARY OF THE INVENTION

In accordance with the present invention, a PDA telephone comprises a wireless headset and a main hand-held unit. The wireless headset includes a first wireless transceiver, a speaker, and a microphone. The speaker and the microphone are coupled to the first wireless transceiver. The hand-held unit receives, processes, and displays personal organizer information. The hand-held unit includes a second wireless transceiver, an antenna, and wireless telephony circuitry coupled to the second wireless transceiver and the antenna. The hand-held unit is free of a telephone speaker and a telephone microphone. The second wireless transceiver transmits incoming audio signals to and receives outgoing audio signals from the first wireless transceiver. By eliminating the speaker and the microphone from the hand-held unit and instead incorporating these items in the wireless headset, the size, weight, cost, complexity, and convenience and efficiency of use of the PDA telephone are optimized.

### BRIEF DESCRIPTION OF THE DRAWINGS

In the drawings:

FIG. 1 is a perspective view of a PDA telephone embodying the present invention; and

FIG. 2 is a block diagram of the PDA telephone.

### DETAILED DESCRIPTION OF THE ILLUSTRATED EMBODIMENT

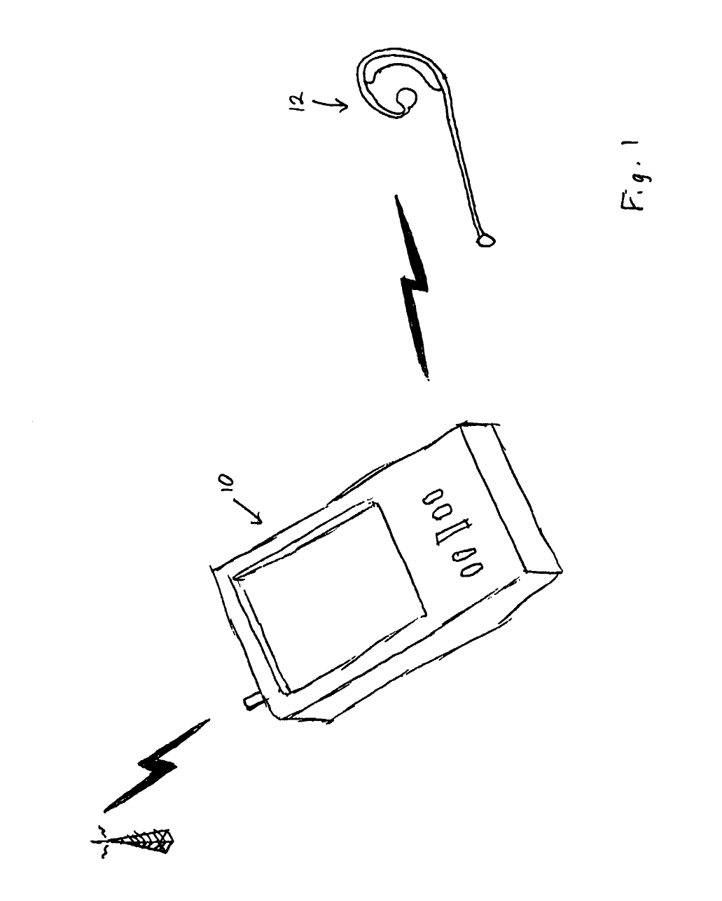

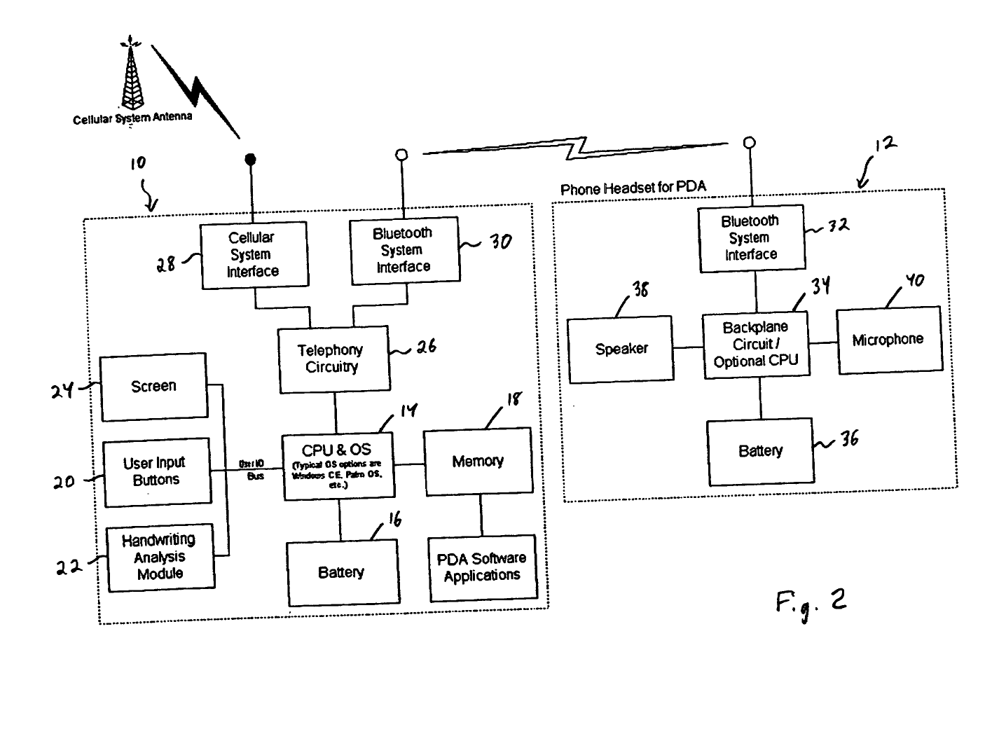

Turning now to the drawings, FIGS. 1 and 2 depict a personal digital assistant (PDA) telephone including a main hand-held unit 10 and a wireless headset 12. The hand-held unit 10 includes a central processing unit (CPU) and operating system (OS) 14. Typical OS options include Windows CE, Palm OS, etc. The CPU/OS 14 is powered by a battery 16 such as a rechargeable or standard AAA battery. A system memory 18 stores PDA application software and data. In one embodiment, the system memory 18 comprises volatile and non-volatile memory such as ROM and battery-backed RAM. However, it will be appreciated that the system memory 18 may be implemented on any of several alternative types of memory structures or may be implemented on a single memory structure.

The CPU/OS 14 receives user commands via user input buttons 20 and a handwriting analysis module 22, and displays PDA software applications and associated information on a video display 24. The video display 24 may, for example, be a liquid crystal display (LCD). Typical information shown on the video display 24 includes personal organizer and telephone information (e.g., names, addresses, telephone numbers, appointments/schedule, calendars, notes). A touch screen is optionally mounted over the video display 24. If the video display 24 is outfitted with a touch screen, the touch screen includes touch keys operable by pressing such keys with a finger, stylus, or the like. The touch keys and the user input buttons 20 may be used to activate the same and/or different PDA functions.

To serve as a telephone, the hand-held unit 10 includes standard wireless telephony circuitry 26 and wireless system interface 28. The wireless system interface 28 is coupled to telephone antenna for transmitting audio signals to, and receiving audio signals from, a wireless (cellular) telephone system. Contrary to existing PDA telephones, the hand-held unit 10 does not include a speaker and microphone. Instead, the hand-held unit 10 includes only a wireless transceiver 30 for transmitting audio signals to and receiving audio signals from a matching transceiver 32 in the wireless headset 12.

The wireless headset 12 includes a backplane circuit 34 having an optional CPU and powered by a battery 36. The battery 36 may, for example, be a rechargeable or standard battery of the AAA or button type. Incoming audio signals from the wireless telephone system are processed and relayed to a speaker 38 inside the headset 12 via the wireless system interface 28, the telephony circuitry 26, the matching transceivers 30 and 32, and the backplane circuit 34. Similarly, outgoing audio signals generated by a microphone 40 (from a user's voice) inside the headset 12 are processed and relayed to the wireless telephone system via the backplane circuit 34, the matching transceivers 32 and 30, the telephony circuitry 26, and the wireless system interface 28. By eliminating the speaker and the microphone from the hand-held unit 10 and instead incorporating the speaker 38 and the microphone 40 in the wireless headset 12, the size, weight, cost, complexity, and convenience and efficiency of use of the PDA telephone are optimized.

In a preferred embodiment, the matching transceivers 30 and 32 are small, inexpensive Bluetooth radio chips that operate in the unlicensed ISM band at 2.4 GHz and avoid interference from other signals by hopping to a new frequency after transmitting or receiving a packet. The radio chips 30 and 32 are plugged into the respective hand-held unit 10 and the wireless headset 12, which can then communicate over short distances and through obstacles by means of radio waves. Bluetooth is a term used to describe the protocol of a short range (e.g., about 10 meters) frequency-hopping radio link between devices containing the radio chips. These devices are then termed “Bluetooth-enabled.” The radio link replaces a cable that would otherwise be used to connect the devices. Further details concerning Bluetooth wireless technology may be obtained from www.bluetooth.com. Wireless technologies other than Bluetooth may be used to communicate audio signals between the hand-held unit 10 and the headset 12.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

What is claimed is:

1. A personal digital assistant (PDA) telephone, comprising:
a wireless headset including a first wireless transceiver, a speaker, and a microphone, the speaker and the microphone being coupled to the first wireless transceiver; and
a hand-held unit for receiving, processing, and displaying personal organizer information, the hand-held unit including a second wireless transceiver, an antenna, and wireless telephony circuitry coupled to the second wireless transceiver and the antenna, the hand-held unit being free of a telephone speaker and a telephone microphone, the second wireless transceiver transmitting incoming audio signals to and receiving outgoing audio signals from the first wireless transceiver.

2. The PDA telephone of claim 1, wherein the incoming audio signals from a wireless telephone system are processed and relayed to the speaker via the antenna, the wireless telephony circuitry, and the first and second transceivers.

3. The PDA telephone of claim 1, wherein the outgoing audio signals generated by the microphone are processed and relayed to the wireless telephone system via the first and second transceivers, the wireless telephony circuitry, and the antenna.

4. The PDA telephone of claim 1, wherein the first and second wireless transceivers include Bluetooth radio chips.
